(19) United States
(12) Patent Application Publication
(10) Pub. No.: US 2009/0304483 A1
(43) Pub. Date: Dec. 10, 2009

(54) Seated Lift for Recreational Vehicles

(76) Inventor: Garlin Cheatham, JR., Hartselle, AL (US)

Correspondence Address: LANIER FORD SHAVER & PAYNE P.C., P O BOX 2087, HUNTSVILLE, AL, 35804-2087, US

(21) Appl. No.: 12/135,701

(22) Filed: Jun. 9, 2008

(51) Int. Cl. B60P 1/00

(52) U.S. Cl. 414/543

(57) ABSTRACT

A lift apparatus for a motor home or recreational vehicle is provided having a generally vertical slide rail attached to the cabin floor and interior wall adjacent the doorway to the motor home or recreational vehicle. A trolley is slidably engaged with the slide rail and is configured for vertical movement through the selectively motorized rotation of a screw about which is engaged a support coupling at the lower end of the trolley A riser is hingedly connected to the trolley, and a swing arm is hingedly connected to the riser. The distal end of the swing arm is configured to have a chair removably mounted to it.

### BRIEF DESCRIPTION OF THE DRAWINGS

The present invention is described with reference to the accompanying drawings. In the drawings, like reference numbers indicate identical or functionally similar elements. Additionally, the leftmost digit(s) of a reference number indicates the drawing in which reference number appears.

FIG. 1 is a perspective view of an exemplary lift apparatus.

FIG. 2 is an elevational view of the lift apparatus of FIG. 1.

FIG. 3A is an elevational view of an alternative embodiment of the left apparatus of FIG. 1.

FIG. 3B is an elevational view of a further alternative embodiment of the lift apparatus.

FIG. 3C is an elevational view of a further alternative embodiment of the lift apparatus.

FIG. 4A is a perspective view of the lift apparatus installed in a recreational vehicle; and

FIG. 4B illustrates the exterior of the recreational vehicle into which the lift apparatus is installed.

### DETAILED DESCRIPTION

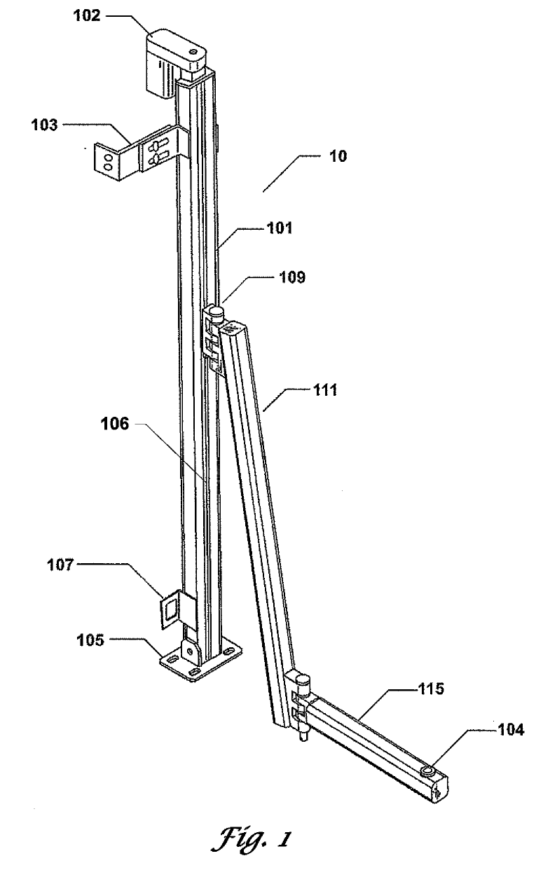

The various embodiments of the present invention and their advantages are best understood by referring to FIGS. 1 through 4B of the drawings. The elements of the drawings are not necessarily to scale, emphasis instead being placed upon clearly illustrating the principles of the invention. Throughout the drawings, like numerals are used for like and corresponding parts of the various drawings.

The drawings represent and illustrate examples of the various embodiments of the invention, and not a limitation thereof. It will be apparent to those skilled in the art that various modifications and variations can be made in the present inventions without departing from the scope and spirit of the invention as described therein. For instance, features illustrated or described as part of one embodiment can be included in another embodiment to yield a still further embodiment. Moreover, variations in selection of material and/or characteristics may be practiced to satisfy particular desired user criteria. Thus, it is intended that the present invention covers such modifications as come within the scope of the features and their equivalents.

Furthermore, reference in the specifications to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” “or variations thereof in various places throughout the specifications are not necessarily all referring to its respective embodiment.

Shown in FIG. 1, an embodiment of the exemplary lift apparatus 10 includes a generally vertical slide rail member 101 with mounting brackets 103, 105 on either end. Motor 102 is mounted via bracket, to the rail 101, preferably on the upper end. Another bracket 107 may be mounted on the lower end to provide support for a wiring harness and/or coupling means that will be described in greater detail below. In this exemplary embodiment, slide rail 101 is a “c” frame having a vertical hollow defined by the rail frame and leaving a slot 106 extending the length of the rail. A trolley 109 is slidably engaged with the rail 101 and is hingedly connected to angled riser member 111 which is in turn hingedly connected to a generally horizontal swing arm 115. Swing arm 115 includes a mounting aperture 104 defined in the free end to receive a post extending from the bottom of a chair when the apparatus is fully installed.

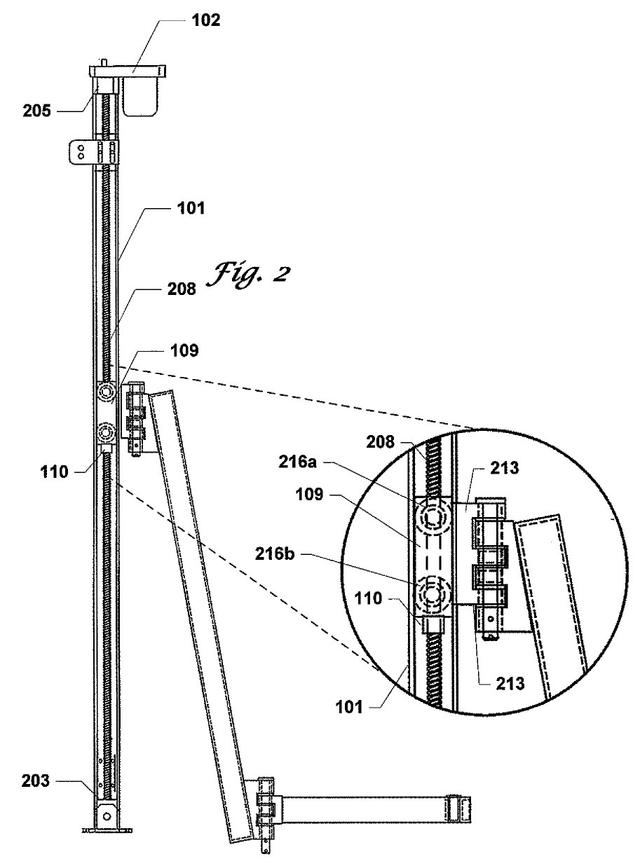

With reference to FIG. 2, near the respective top and bottom ends are mounted within rail 101 screw upper and lower support bearings 205, 203 respectively, in which a screw 208 is is mounted. Screw 208 is threadably engaged with the trolley 109 through threaded support coupling 110, in the lower portion of the trolley 109, as shown in greater detail in the magnified view shown in the inset. Those skilled in the relevant arts will appreciate that other structures are available in which to threadably couple trolley 109 to screw 208. As can also be seen in the inset, trolley 109 is slidably seated within the C-frame of the rail 101, having a generally vertical flange 213 which extends through the slot to support the hinge 215. Trolley 109 may include lateral extensions which engage the inner portion of the rail frame. Such lateral extensions may include wheels 216a, b to provide substantially frictionless movement within the slide rail hollow.

Motor 102 is coupled to screw 208 the screw 20 through the upper screw support bearing 205. Motor 102 is configured, therefore, to generate rotation which transmitted to the screw 208 through upper bearing 205. It will be apparent to those skilled in the art that coupling the motor to the screw 208 will result in only minute torque being applied to the upper portion of the rail 101.

In operation, motor 102 applies torque to the screw 208 which rotates and causes the trolley 109 to move along the rail in one of two directions depending upon the direction of movement selected by the operator.

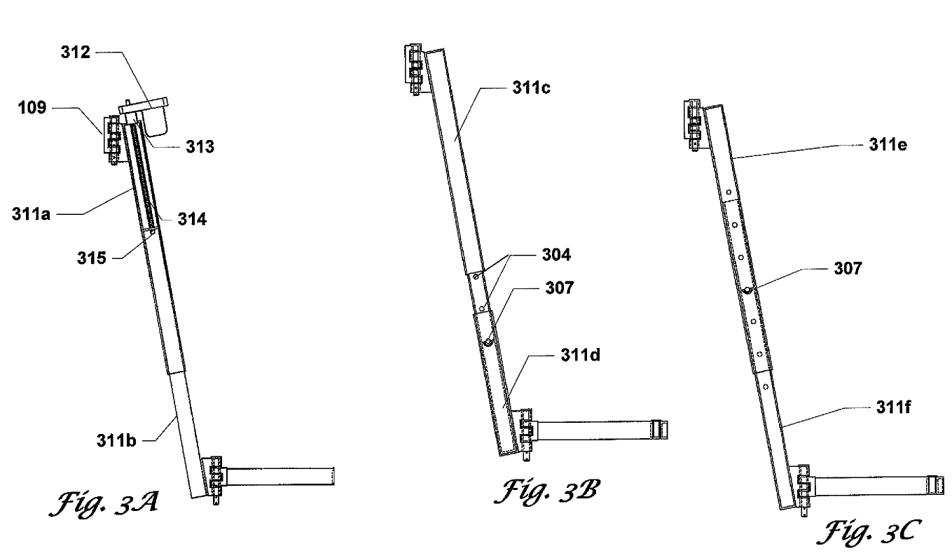

FIGS. 3A-3C depict exemplary embodiments of adjustable lift apparatuses 10. In one embodiment, angled riser is adjustable in length. For an example, as shown in FIG. 3A, a motor 312 is rotatably coupled to a screw 314 through a screw support bearing 313. In this manner, an upper portion of angled riser 311a is affixed to the upper portion of 311b by swivel mount 315 which allows screw 314 to rotate freely but still bear the load of the lower portion 311b. In operation, motor 312 applies torque to the screw 314 which rotates and causes 311b to move in one of two directions depending upon the direction of movement selected by the operator.

An exemplary embodiment depicted in FIG. 3B shows a version where upper portion 311c is received within the lower portion 311d. Each portion includes corresponding, spaced-apart holes 304 bored through the respective portion, into which may be inserted a pin 307.

In another exemplary embodiment depicted in FIG. 3C, an upper portion of angled riser 311e has a hollow lower end. Such lower end receives an upper end of an angled riser 311f. Each portion includes corresponding, spaced-apart holes 304 thought the respective portion into which may be inserted the pin 307.

The ability to adjust allows the lift apparatus to be used when the vehicle is parked perpendicular to a downward slope, or decline. In such condition, the side of the vehicle toward the decline is usually raised by jacks or stabilizing feet so that the vehicle may be leveled. The riser length may be suitable for use in situations where the vehicle is parked on level ground, but if the vehicle is parked on a decline as describe above, the chair, may be too high for someone to sit in if trying to enter the vehicle, or too high from which to alight to the ground if exiting, and the lift apparatus would be useless. Thus, the riser may be adjustable to extend the chair and swing arm lower in those situations.

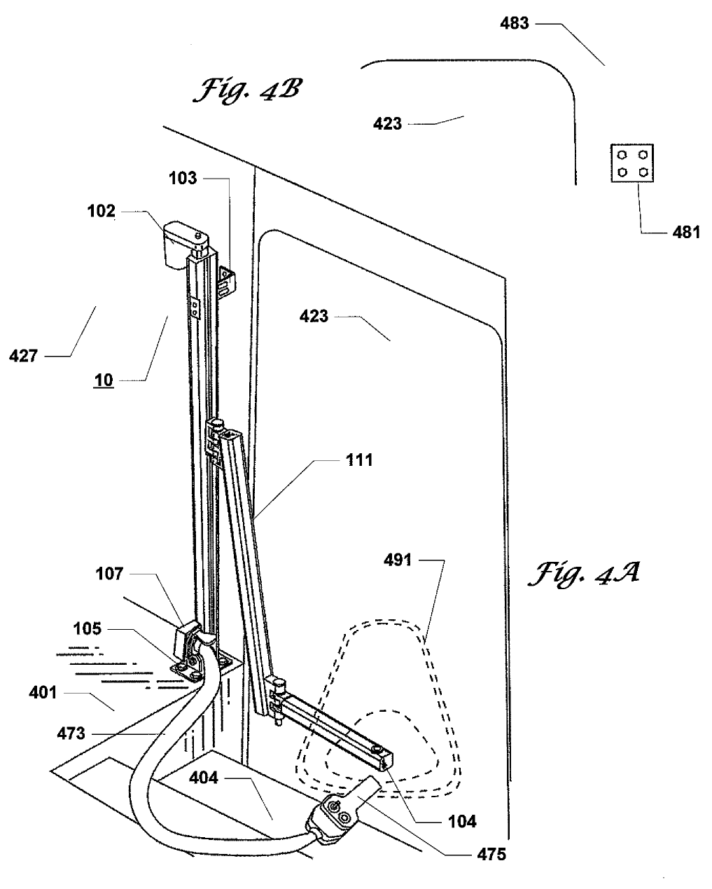

FIG. 4A illustrates the apparatus 10 installed in a recreational vehicle. Recreational vehicles typically include a doorway 423 through which a person may enter the cabin via a stairwell 404 which leads to the main deck 401 of the cabin. The lift apparatus 10 is installed against the vehicle bulkhead 427 roughly adjacent the doorway 423 by fasteners inserted into apertures (not shown) in upper and lower mounting brackets 103 and 105 and through corresponding apertures in the vehicle bulkhead 427 and main deck 401, respectively. Lift apparatus 10 is installed so that angled riser 111 extends down into the stairwell 404 and swing arm 115 may extend across the stairwell 404, within the doorway 423. Upper mounting bracket 103 is shown to be mounted against the interior bulkhead 427. As shown in FIG. 4B, a plate 481 may be affixed to the exterior vehicle wall 483 by the fasteners securing the upper bracket 103 to the interior bulkhead 427. This provides support for the wall to prevent tearing or cracking thereof. Chair 491 is set upon the swing arm 115 and is allowed to pivot. Chair 491 is therefore configured with a post extending from the under side of its seat portion that is removably inserted into swing arm aperture 104.

Motor 102 is on top of the rail 101 and its operation is controlled with a control switch 475 coupled thereto with control wiring 473. Wiring 473 may be removably coupled to motor 102 through wiring bracket 107 mounted near the lower support bracket 105. Motor may be any suitable electric motor capable of imparting torque to the lift system, and should preferably be capable of bi-directional operation in order to enable up and down movement of the trolley. For example, motor could be a 12 Volt motor. Control switch 475 should therefore also be configured to provide suitable bidirectional control to the operator. In other words, the operator needs to be able to command forward and reverse operation of the motor.

Operation of the lift apparatus will now be described. To enter the vehicle, the trolley should be at its lowest point. Swing arm 115 (with chair 491) is rotated through the doorway 423 to the exterior of the vehicle, along with riser 111, by virtue of the respective hinged connections. The operator sits in the chair 491, and using the control switch 475, commands the motor 102 to rotate the screw 208 causing the trolley 109 and the chair 491 to elevate. Once at the desired height, the operator may command the motor 102 to stop, and rotate the swing arm 115 with the chair 491 to the interior of the vehicle.

It will be appreciated that the lift disclosed herein is useful for those who are incapable of ascending stairs to enter such vehicles. Accordingly, angled riser 111 should be of a length such that when the trolley is at its upper most point, the user may simply stand up from the chair and rest his or her feet on the main deck 401. Further, the angle of the riser should be of a degree that given the length of the riser and the length of the swing arm a chair mounted to the swing arm is centered within the width of the doorway.

The above-described lift has many advantages over known lifts used in the industry. Such pre-existing lifts are installed on the outside of the vehicle adding width. They are also installed by the manufacturer and result in modifications to the frame and removal of storage space within the vehicle. Specifically, typical prior art lifts require the doorway to widened to place the chair into the center of the doorway when the chair is lifted. Manufacturers typically realize greater profit on uniformity of frame and the furnishings inside the RV. Such modification result in increased cost through not only the labor and time involved, but also in the redesign and refurnishing of the interior of the RV.

The present lift may be installed by anyone without any modifications to the bulkhead and cabin floor, and thus is suitable for use in any standard RV configured as described above. For travel and for unassisted entry/exit of the vehicle, the chair may be easily removed and the riser/swing arm assembly removed and/or folded to the interior of the vehicle, out of the stairwell. Further, the lifts are installed so that all storage space is still usable.

As described above and shown in the associated drawings, the present invention comprises a seated lift for recreational vehicles. While particular embodiments of the invention have been described, it will be understood, however, that the invention is not limited thereto, since modification may be made by those skilled in the art, particularly in light of the foregoing teachings. It is therefore, contemplated by the following claims to cover any such modification that incorporate those features or improvements that embody the spirit and scope of the present invention.

1. A lift apparatus for recreational vehicles that include a doorway within which is an interiorly disposed stairwell leading up to a cabin, the cabin having a floor and defined by interior walls, said lift apparatus comprising:
a) a generally vertical rail member having a first mounting bracket attached to a bottom end thereof for mounting said bottom end to the cabin floor in proximity to the doorway, and a second mounting bracket attached to the upper end of said rail for securing said top end to the interior wall of the cabin;
b) a trolley slidably engaged with said rail member;
c) a screw affixed to said rail member near said top end, said screw threadably engaged with said trolley such that as the screw is rotated the trolley moves vertically;
d) a motor mechanically coupled to the screw operable for selectively applying torque in either direction to said coupled screw;
e) an angled riser member hingedly coupled to said trolley and extending downward toward the stairwell; and
f) a swing arm hingedly coupled to said riser member extending across said stairwell.

2. The lift apparatus of claim 1, wherein said swing arm includes a mounting aperture defined in an end thereof distal from said hinged coupling for receiving a post extending from the underside of a chair.

3. The lift apparatus of claim 2, wherein said riser member is angled such that when said chair is mounted to said swing arm, said chair is toughly centered within the doorway.

4. The lift apparatus of claim 1, wherein said motor is a 12-volt electric motor.

5. The lift apparatus of claim 1, fisher comprising a mounting support plate mounted to an exterior wall opposite said second mounting bracket secured to said interior wall.

6. The lift apparatus of claim 1, wherein said rise member is adjustable in length.

7. The lift apparatus of claim 7, wherein said swing arm includes a mounting aperture defined in an end thereof distal from said hinged coupling for receiving a post extending from the underside of a chair.

8. The lift apparatus of claim 8, wherein said riser member is angled such that when said chair is mounted to said swing arm, said chair is roughly centered within the doorway.

9. The lift apparatus of claim 9, wherein said motor is a 12-volt electric motor.

10. The lift apparatus of claim 9, further comprising a mounting support plate mounted to an exterior wall opposite said second mounting bracket secured to said interior wall.

11. The lift apparatus of claim 9, wherein said riser member is adjustable in length.
